(19) United States
(12) Patent Application Publication
(10) Pub. No.: US 2024/0343543 A1
(43) Pub. Date: Oct. 17, 2024

(54) IMPROVED TELESCOPIC LOADER

(71) Applicant: Danfoss Power Solutions GmbH & Co. OHG, Neumünster (DE)

(72) Inventor: Erik WESTERGAARD, Aabenraa (DK)

(21) Appl. No.: 18/294,055

(22) PCT Filed: Jul. 21, 2022
(86) PCT No.: PCT/EP2022/070514

§ 371 Date: Jan. 31, 2024

(30) Foreign Application Priority Data
Aug. 13, 2021 (DE) 10 2021 121 163.8

(51) Int. Cl. B66F 17/00; B66F 9/065; B66F 9/075

(52) U.S. Cl. CPC B66F 17/003; B66F 9/0655; B66F 9/0755

(57) ABSTRACT

A method (30) of actuating a variable boom loading arrangement (1) that includes a variable length boom (2) that can be extended and retracted using a length actuator (3). A first end of the variable length boom (2) is pivotally attached to a frame, and the variable length boom (2) can be pivoted relative to the frame by means of a pivot actuator (5). A second end of the variable length boom (2) is used for handling loads. An input command that is given by an operator is modified if the variable boom loading arrangement (1) reaches a predefined tipping moment, resulting in a modified output command to the actuators (3, 5), so as to avoid a tipping of the variable boom loading arrangement (1). The input command is used to calculate an unmodified commanded direction of the second end of the variable length boom (2) in an external reference frame, in particular in an external Cartesian coordinate reference frame, wherein the modification scheme that is applied to the input command and that results in a modified output command to the actuators depends on the calculated unmodified commanded direction in the external reference frame.

### CROSS-REFERENCE TO RELATED APPLICATION

This application is a National Stage application of International Patent Application No. PCT/EP2022/070514, filed on Jul. 21, 2022, which claims priority to German Patent Application No. 10 2021 121 163.8, filed Aug. 13, 2021, each of which is hereby incorporated by reference in its entirety.

### TECHNICAL FIELD

The invention relates to a method of actuating a variable boom loading arrangement, comprising a variable length boom that can be extended and retracted using a length actuator, wherein a first end of the variable length boom is pivotally attached to a frame, and wherein the variable length boom can be pivoted relative to the frame by means of a pivot actuator, and wherein a second end of the variable length boom is used for handling loads. The invention also relates to a variable boom loading arrangement comprising an input device, a variable length boom that can be extended and retracted using a length actuator, wherein a first end of the variable length boom is pivotally attached to a frame, and wherein the variable length boom can be pivoted relative to the frame by means of a pivot actuator, wherein the telescopic boom comprises a tool mount at a second end of the variable length boom.

### BACKGROUND

Telehandlers, telescopic wheel loaders and similar machinery are nowadays a familiar sight in quite some areas of application. A typical area of application is agriculture or construction sites.

An intrinsic problem of telehandlers and telescopic wheel loaders is that due to their very basic design it is possible to bring the tool into a position where a severe risk of tipping forward of the vehicle is present, or where a tipping over behaviour of the vehicle is even unavoidable. In particular, if the telescopic boom is fully extended and additionally brought to a somewhat horizontal attitude, the centre of gravity of the vehicle can easily move forward of the forward axle, even when not too excessive loads are placed on the tool. Thus, for a fully extended telescopic arm in an essentially horizontal position, a tipping over can occur even with relatively small loads. However, if the extension of the telescopic arm and its angle with respect to the horizon/surface is limited, larger loads can be handled. These considerations are well known in the prior art. An operator of the respective machinery is informed about the operatable range of the telescopic arm (extension/angle) for certain load limits by so-called load charts.

Since there is nevertheless a certain risk that an operator accidentally exceeds the limit of operation for a certain load, in the meantime an automated safety mechanism is required in several jurisdictions, so to avoid tipping over of the vehicle. An example for this is the EN15000 standard for telehandlers. For telescopic wheel loaders, a similar regulation is to be expected in the near future under EN474-3 (EN=European Norm).

The most straightforward idea is to simply stop a lowering movement and/or an extension movement of the telescopic load arm, if the respective operatable range for a certain weight is prone to be exceeded (where a safety margin applies, of course). The current weight is typically measured using weight sensors. While this simple approach does the job, it is nevertheless annoying since depending on the operator input, this can result in hard stops, causing a significant strain on the mechanical setup of the working vehicle. Further, it is even possible that the load moves on the tool (for example a fork), or even falls off.

To alleviate this problem, it was already suggested to use a “soft stop”. As an example, EP 2 520 536 B1 defines a plurality of work sub-areas, where the work sub-areas are defined by the load, the length and the angle of the telescopic boom. Depending on the work sub-area, the maximum speed of lowering of the boom is limited to a predefined limit.

Another approach was suggested in EP 2 736 833 B1, where depending on the load on the boom and its angle with respect to the horizon, a maximum possible movement speed is calculated for the moving operating arm which prevents an inadmissible tilting movement of the working vehicle (tipping over). The actually applied movement speed is limited to the calculated maximum possible movement speed, irrespective of the operator input.

EP 3 702 311 A1 discloses a working machine that has a body and a load handling apparatus coupled to the body. The load handling apparatus is moveable with respect to the body by an electrically driven actuator assembly. A controller is configured to receive a tilt signal representative of a moment of tilt of the working machine and to issue a control signal configured to control an electrical drive element of the electrically driven actuator assembly based on the value of the tilt signal relative to a tilt threshold.

WO 2015/192034 A1 describes a work vehicle that includes a frame assembly and an attachment assembly. The attachment assembly has an attachment end which is pivotally connected to the frame assembly and a distal end which is configured for receiving a variable load. One or more force sensors sense a plurality of forces associated with the attachment end, with each force sensor providing an output signal representing at least one sensed force. An inclination sensor senses an inclination associated with the frame assembly relative to a horizontal reference. The inclination sensor provides an output signal representing the sensed inclination. An electrical processing circuit is coupled with each force sensor, the inclination sensor and a controllable output. The electrical processing circuit is configured for receiving the output signal from each force sensor, determining a value of a couple at the frame assembly which is associated with the sensed forces, comparing the couple with a threshold value which is dependent on the sensed inclination, and controlling the controllable output dependent on the comparison.

While the previously mentioned suggestions surely show an improvement over the afore described most straightforward approach, they are still deficient. A major problem exists in that they are slowing down and eventually stop the movement of the boom. This may slow down loading/unloading operations, in particular for unskilled operators that frequently do run into the set limits, thus adversely affecting productivity.

Therefore, there is a clear desire in the technical field for an improved operational behaviour of telehandlers, telescopic wheel loaders and the like.

### SUMMARY

Therefore, the object of the invention is to suggest a method of actuating a variable boom loading arrangement, comprising a variable length boom that can be extended and retracted using a length actuator, wherein the first end of the variable length boom is pivotally attached to a frame, and wherein the variable length boom can be pivoted relative to the frame by means of the pivot actuator, and wherein the second end of the variable length boom is used for handling loads, and that is improved over methods of this type that are known in the prior art.

Another object of the invention is to suggest a variable boom loading arrangement, comprising an input device, a variable length boom that can be extended and retracted using a length actuator, wherein a first end of the variable length boom is pivotally attached to a frame, and wherein the variable length boom can be pivoted relative to the frame by means of a pivot actuator, wherein the telescopic boom comprises a tool mount at a second end of the variable length boom, and that is improved over similar variable boom loading arrangements that are known in the prior art.

A method and a variable boom loading arrangement according to the independent claims solve these objects.

A method of actuating a variable boom loading arrangement, comprising a variable length boom that can be extended and retracted using a length actuator, wherein a first end of the variable length boom is pivotally attached to a frame, and wherein the variable length boom can be pivoted relative to the frame by means of a pivot actuator, is suggested. A second end of the variable length boom is used for handling loads, wherein an input command that is given by an operator is modified if the variable boom loading arrangement reaches a predefined tipping moment, resulting in a modified output command to the actuators, so as to avoid a tipping over of the variable boom loading arrangement. The input command is used to calculate an unmodified commanded direction of the second end of the variable length boom in an external reference frame, in particular in an external Cartesian coordinate reference frame, wherein the modification scheme that is applied to the input command and that results in a modified output command to the actuators depends on the calculated unmodified commanded direction in the external reference frame.

The variable boom loading arrangement of the presently suggested type is typically used in connection with a vehicle, in particular a work vehicle. Depending on the exact design of the variable boom loading arrangement, the design is typically equivalent to the mechanical boom setup of a telehandler, teleloader, telescopic wheel loader or the like. However, it is to be understood that the presently suggested method also works if more/a plurality of booms is/are used, in particular if two or more booms are attached to each other as some kind of a “mechanical series”, i.e. in a way that a first boom is attached to a chassis with its first end; the second end (opposite) thereof is used as a hinging mount for the second end of the first boom and a first end of the second lever; and the second end of the second boom is used as a tool mount, just to name an example. Certainly, even three, four or five booms may be connected in series as well. For a person skilled in the art, it is obvious to generalise the presently suggested idea to such an arrangement.

According to the present suggestion, (at least) one boom (possibly a single boom) is of a variable length. The variable length boom can be extended and retracted using a length actuator. Preferably, the variable length boom shows (an essentially) “clean” extension/retraction behaviour, i.e. that apart from the length variation no bending, hinging, kinking, tilting or the like occurs. Nevertheless, it is likewise possible that a certain angular movement (some kind of a hinging point, a kinking point, tilting point, bending point or the like) might be present. Typically, the second end of the variable length boom, i.e. the end of the variable length boom that is used for handling loads, shows a tool mount, so that a tool can be attached to the variable length boom and/or shows a tool that is mounted to the second end of the variable length boom (possibly using a tool mount, so that the tool can be changed by a spare one/a different type of tool). The first end and the second end of the variable length boom are normally arranged at opposite ends of the variable length boom, when seen in its lengthwise extension. For mechanical reasons, the part of the first and/or second end that is meant to be used for mechanical connections is usually located a short distance away from the outer contour line of the variable length boom. As an example, a bore that is used for insertion of a pivoting bolt will usually be placed at a distance of several centimetres from the outer contour of the variable length form. The length actuator can be of an essentially arbitrary design and/or may use various energy forms. As an example, hydraulically actuated length actuators, electrically actuated length actuators, mechanically actuated length actuators or the like may be employed. Likewise, different actuation techniques might be employed, like axially working actuators (as an example: a hydraulic piston or a linear electric drive) or rotating actuators (for example: a hydraulic or electric motor that drives a cogwheel that engages in a cograil).

As a matter of completeness: In case a tool or tool mount (or even another boom) is attached to the second end of the variable length boom, in a typical arrangement this connected device may be actuated as well, for example using a tilt actuator for the tool and/or for the tool mount.

The input command is given by the operator, using essentially arbitrary input techniques. In particular, input techniques that are customary in in the present field of technology may be used, like control levers, input joysticks or the like. The operator may sit in the vehicle, or may drive the vehicle using a remote control. Further, it is also possible that at least for certain movements an automatic device drives the vehicle, or at least supports the driver. As a matter of completeness: while in the present context the variable boom loading arrangement is usually discussed in the context of being placed on a (land) vehicle, a different arrangement is likewise possible. Just to name an example: the arrangement may be placed on a train car, a trolley of a crane, a ship or the like.

When talking about the “predefined tipping moment” this may relate to “an absolute limit”, i.e. a limit that is not to be exceeded under any circumstances (this might relate to the actual tipping limit of the vehicle, usually comprising a safety margin; the safety margin may comply to current construction layouts, good construction practice and/or current legislative requirements). However, the “predefined tipping moment” can also relate to one or several “warning limits”, i.e. a limit where a further actuation is still allowed, however under certain precautions. As an example, the maximum actuation speed may be limited to a certain limit. Upon reaching the ultimate limit, however, no further actuation should be possible. It is to be noted that a plurality of predefined tipping moment levels, each one typically showing a different maximum allowable speed, may be advantageously employed.

However, it should be noted that the modification scheme not only relates to speed limitations. In this context, it has to be stressed that the speed limitation may be different for different actuation directions. The actuation direction/actuation speed in this context may relate to the framework (coordinate system) of the actuators that are used, i.e. to the length actuator and/or the pivot actuator. However, in this context it may also relate to the framework of an external reference frame (in particular a Cartesian reference frame). Furthermore, the modification can additionally or alternatively relate to a modification of the commanded direction as well (actuator framework and/or external reference framework). Both modification schemes can of course interact with each other and/or may be dependent on each other.

In any case, the input command by the operator is processed as to calculate the direction of the second end of the variable length boom in an external reference frame (typically the horizon, the vehicle chassis, the surroundings or the like; in case a telehandler is used on a ship, the external reference frame would be the ship). This calculation is done using the unmodified command, i.e. using the raw input by the operator. Depending on this calculated direction, the raw input will undergo a modification scheme, before being finally applied to the actuators. Usually, a plurality of different modification schemes exists, where typically a differentiation is made with respect to the angle α that encloses the commanded (raw) direction and a forward direction in the external reference frame. This may be employed in form of a sharp changeover; however, transitional regimes may be employed as well. In particular, a modification scheme in this sense may also relate to through putting the raw input and applying it to the actuators without any modification. This is particularly suitable for actuated directions that do bring the variable boom loading arrangement away from the (or possibly one out of a plurality of) predefined tipping moments, i.e. into a “safer position”. “Bringing away the variable boom loading arrangement from the predefined tipping moment” can be particularly understood as a reduction of the tipping moment. It is to be understood that a real and/or noticeable modification is usually not sensible in case of such an actuation. However, for different directions, in particular when approaching and/or reaching one or more predefined tipping moments and when additionally the raw actuation would bring the arrangement in more danger of tipping over, a real and noticeable actuation should be employed.

In the context of the present description an angle α will be used for describing the unmodified commanded direction (raw direction). The angle is defined in a way that α=0 for a forward pointing direction of the variable boom loading arrangement (vehicle, work vehicle, telehandler, telescopic wheel loader, etc.). In case of a vehicle, this is the forward moving direction of the vehicle, in particular as seen in the external reference frame. If an upward aspect is added, the angle α increases. A vertical upward direction is equivalent to a degree of α=90°. Quadrant I is defined by an angle 0°≤α≤90°. Between a vertical upward movement (α=90°) and a horizontal backward movement (α=180°) lies quadrant II. Quadrant II is equivalent to an angle 90°≤α<180°. α=270° is equivalent to a vertical movement downward. Therefore, quadrant III is equivalent to 180°≤α≤270°. Further, quadrant IV is equivalent to 270°≤α<360°. It is to be noted that a becomes repetitive after 360°, so α=360° is equivalent to α=0°. As another example: α=−10° is equivalent to α=350°.

It is to be noted that the corrective intervention according to the presently proposed method may be clearly noticeable by the operator. Actually, this is usually even an advantage, because the operator made an “erroneous input”. The big difference with respect to previous actuation schemes is that at least for certain operator inputs and certain ranges of operation the operation of the variable boom loading arrangement is not simply slowed down or even stopped, which results in a lower productivity. Instead, it is possible—and usually preferred—to modify the operator input in a way that it resembles or even mimics the operator input (raw operator input) that would be made by an experienced operator. This makes it understandable that it is advantageous that an (unexperienced) operator will clearly notice the intervention because it sort of teaches him how he should actuate the arrangement in the future. It is even possible to couple an intervention of the method with a warning light, a counterforce of a force feedback joystick or the like. “Intervention” in the present context may mean that there is an objective difference between the commanded input command by the operator (raw command) and the applied command that is actually applied to the actuators (which may relate to the size and/or the direction of the command). The method according to the present suggestion therefore can make the unexperienced operator work similar to an experience operator. At the same time the experienced operator is usually not impeded in his productivity.

It is further suggested to employ the method in a way that the data of at least one load sensor, one position sensor and/or one angle sensor is used as an input for determining the predefined tipping moment. This way, the limits that are given by the mechanical setup and the current load can be exhausted to the very limit (where the limit can relate to a limit plus a safety margin and/or a legal limit, of course. A tipping moment is often expressed as a percentage (%), where 100% usually is equal to tipping over occurring; the tipping moment is frequently used even with nowadays machinery; practically this is determined through calibration of a certain weight on the tool close to tipping and a consequent measurement without a weight). Also, even further data (from other sensors or from somewhere else) may be used as well. This way, a particularly efficient use of the variable boom loading arrangement, the method is used for, can be realised. On the other hand, a tipping over of the variable boom loading arrangement (or a situation, where the variable boom loading arrangement comes to close to a limit or to the tipping over borderline) can be avoided. This is, because less false assumptions can be made, resulting in a more realistic picture of the real situation.

Furthermore, it is suggested to employ the method in a way that the second end of the variable length boom relates to a tool mounting point. This way, the variable boom loading arrangement can be made particularly versatile. In particular, such a design will resemble arrangements and/or work vehicles that are commonly used in present day industry and by present day consumers. In particular, telehandlers, telescopic loaders, excavators, telescopic wheel loaders and the like may be envisaged by this design. It is to be noted that a tool may be attached to the tool mounting point, where the tool is preferably replaceable. In principle, however, a tool may be fixedly mounted to the tool mounting point (which does not exclude the possibility that the tool can be changed in a workshop or the like, when worn out). In particular, the tool mounting point (the tool mounting device) may be actuated as well. As an example, a tilting actuator, in particular a tilting hydraulic piston, can be employed for realising a pivotable and/or tiltable tool mounting device and/or tool that is attached to the tool mounting device.

Furthermore, it is suggested to employ the method in a way that the predefined tipping moment comprises a critical tipping moment, where irrespective of the commanded actuation of at least one of the actuators, the modified output command to the respective actuator is 0, at least for certain modification schemes and/or at least for certain calculated unmodified commanded directions in the external reference frame. Using this design, in particular mechanical requirements can be complied with, so as to positively avoid any tipping over behaviour when a critical tipping moment is reached/exceeded, or to positively avoid an imprecise behaviour of the arrangement, if the arrangement is very close to a point before real tipping occurs. Even more, legal requirements can be fulfilled when employing this embodiment. It is to be noted that the critical tipping moment normally does not relate to a situation, where a tipping over behaviour of the arrangement actually occurs. Instead, usually a safety margin will be employed. The safety margin can be chosen in particular from the group, comprising the following possibilities (combination of two or more of those possibilities is possible as well): a) Mechanical tipping over would occur if the load would be increased by more than 1%, 2%, 3%, 4%, 5%, 10%, 15%, 20%, 25%; b) The vertical plane, defined by the reference position of the attached tool that reflects its centre of mass (in case of a fork, this may be located approximately in the middle of the lengthwise extension of the forks), and that is normal to the lengthwise extension of the variable boom loading arrangement/vehicle has reached 95%, 90%, 85% or 80% of the position, where a tipping over behaviour of the arrangement occurs; c) the tool/tool mounting point/tool mount/second end of the variable length boom has reached a position of up to 1 m, 75 cm, 60 cm, 50 cm, 40 cm or 30 cm before a tipping over occurs; d) the percentage of the tipping moment (as described above) has a reached 95%, 90%, 85% or 80%. Again, for certain directions of the commanded direction (raw direction), no modification schemes may be applied (or so-to-say: a modification scheme is chosen, so that no modification occurs). In particular, if the variable boom is retracted and/or the boom is lifted upward, the arrangement will move away from the critical tipping line; therefore, this movement is safe and can be effectuated, as requested by the operator. This is usually equivalent to a commanded direction in quadrants II and III.

Furthermore, it is suggested to employ the method in a way that the predefined tipping moment comprises a range between an upper bound tipping moment and the critical tipping moment, wherein an only reduced amount of the commanded actuation of at least one of the actuators is applied to the respective actuator as the modified output command, at least for certain modification schemes and and/or at least for certain calculated unmodified commanded directions in the external reference frame, wherein preferably the fraction of the commanded actuation is monotonically decreased, and in particular linearly decreased. This way, a soft stopping behaviour without any hard stop can be advantageously realised. Hence, it is possible that mechanical wear of the variable boom loading arrangement, as well as the generation of noise can be reduced. Furthermore, an unwanted shifting of any goods that are placed on/contained in the tool can also be advantageously avoided. In disadvantageous conditions goods could even fall off/outside of the tool, which can be avoided with the presently suggested embodiment. Another effect of a lower speed is that inertial effects that can introduce a tipping moment on their own are reduced due to the lower speed. The distance between the upper bound tipping moment and the critical tipping moment can be chosen as a certain percentage of the overall possible distance (for example 90% or 95%) and/or can be chosen as a fixed distance, like 30 cm, 20 cm, 10 cm of 5 cm. This distance may particularly relate to the closest distance between a plane that is normal to the forward moving direction of the vehicle/a vector pointing in the direction α=0, and the forward axle of the vehicle. Again, no modification will be applied (or the modification scheme will keep the commanded input command unaltered) if, for example, the boom is moving upward/backward, meaning that the variable boom loading arrangement moves away from the predefined tipping moment (upper bound tipping moment/critical tipping moment). This is usually equivalent to a commanded direction in quadrants II and III.

Furthermore, it is suggested that below a certain size of the input command the commanded actuation of the actuators will be modified in a way that the calculated unmodified commanded direction in the external reference frame is not changed, at least for certain modification schemes and/or at least for certain calculated unmodified commanded directions in the external reference frame. In particular, the “no directional change modification” will be used for (essentially) all modification schemes and/or for (essentially) all calculated unmodified commanded directions in the external reference frame. It is to be noted that when an operator wants to command a final placement of goods—or on the contrary—wants to pick up goods, he does not want to have a change of direction of the tool, because then he could contact parts in the surrounding area or the like. It is to be noted that this final placing/pickup will usually always be done with a small/slow operator input (fine tuning, delicate operation). Hence, the “worst” that can happen to the operator is that the operation is further slowed down or brought to a halt. Then, the operator can (and usually has to) correct for the problem by alternative approaches, if possible. As an example, he could retract the boom, move the vehicle in the forward direction, and try to place the goods a second time. Again, it should be noted that this approach will usually be the approach that would be chosen by a skilled operator. Only as a matter of completeness, it is agreed that for this very aspect of the presently proposed method, the operating throughput is indeed reduced and hence productivity decreased. However, less productivity is definitely better as compared to damage of goods and/or surroundings. Furthermore, even here the presently proposed method is not inferior to present-day approaches. In particular, a slow/small input command may relate to a setting that is less than (or equal to) 1%, 2%, 3%, 4%, 5%, 10%, 15% or 20% of the maximum actuation speed in at least one of the various directions (machine frame/reference frame).

Even further, it is suggested to employ the method in a way that the commanded actuation of the actuators is not modified if the calculated unmodified commanded direction in the external reference frame brings the second end of the variable length boom away from the predefined tipping moment, in particular from the critical tipping moment and/or from the upper bound tipping moment. This is typically equivalent to a movement with an angle α lying in quadrants II or III. As already mentioned previously, such a commanded actuation is intrinsically safe in a way that the tipping moment is reduced. Therefore, no alteration is necessary. On the contrary, slowing down of the movement would unnecessarily reduce productivity, which is of course undesired.

Furthermore, it is suggested to employ the method in a way that in case the unmodified commanded direction points in an upward and forward direction, the modification scheme reduces the input command of the length actuator, while it maintains the input command of the pivot actuator. This is usually equivalent to an angle 0°≤α<90° or to quadrant I. In this direction, some sort of a contradicting combination occurs, in that the lifting actuation of the variable length boom brings the arrangement away from the predefined tipping moment, while on the other hand extension of the variable length boom will bring it closer to the predefined tipping moment. Therefore, the “safe” aspect of the command (i.e. the upward movement command) is maintained, while the “unsafe” aspect of the command is reduced. In particular, the reduction can be done in a way that a (linear) reduction of the amount of the commanded extension movement starts to be reduced when reaching an upper bound tipping moment (factor 1) and is reduced to 0 when reaching the critical tipping moment. The reducing factor that is applied may be dependent on the commanded speed/commanded fluid flow toward the respective actuator.

Further, it is suggested that in case the unmodified commanded direction points in a forward and predominantly downward direction, the modification scheme maintains the input command of the pivot actuator, while the input command of the length actuator is modified in a way that the actual direction of the second end of the variable length boom is the vertical (downward) direction. In case the available actuation power is not sufficient to maintain this modification scheme, the modification scheme reduces the input command of the length actuator and the input command of the pivot actuator, wherein the reduction is chosen in a way that the actual direction of the second end of the variable length boom is the vertical downward direction and the available actuation power can maintain the modified command. Here, the unmodified commanded direction usually lies in the sector of quadrant IV that lies between quadrant II and the α_{IV}-line, i.e. 270°≤α<α_{IV}; where (α_{IV}=α_{IV,i}+α_{IV,ii}). It is to be noted that the command by the operator is interpreted in a way that the operator wants to lower the load, but does not apply a sufficiently large corrective retraction command of the variable length boom. Therefore, the method will interpret this command accordingly and perform a pure vertical lowering. Such a vertical lowering of the goods is “safe” in a way that it does not increase the tipping moment (albeit it does not decrease the tipping moment either). Indeed, if an experienced operator wants to perform a fast lowering movement (in particular in case the variable boom loading arrangement is somewhat close to the predefined tipping moment), he would usually try to command a vertical lowering (as seen from the external reference frame) by applying a corrective retraction of the boom. Therefore, the corrective behaviour by the machinery does same thing, a skilled operator would do. A difference between the command, as given by the operator, and the actual behaviour of the machinery is a good indication for the operator, that his commands are not optimum. It is to be noted that it is not uncommon that the available actuation power for the actuators (as an example: the available hydraulic fluid flow for hydraulic pistons) is not sufficient to realise the suggested vertical downward movement, while maintaining the input command of the pivot actuator, as commanded. Then, the command that is actually applied to the actuators will be reduced for both actuators in a way that a vertical downward movement is realised, while the overall power consumption by the actuators can still be met by the available power. In particular, the overall power demand can be set to be the same as the available power (100%), or can be chosen to be somewhat lower to have a safety margin of surplus power (for example 90%, 95%, 97%, 98%, 99%). In principle, the well known scheme of “electronic flow sharing” is used. The same applies in analogy if the power that can be applied to one of the actuators/to both actuators is limited for any other reason. An example would be that in principle sufficient hydraulic fluid flow is available, but the cross section of the valve or of the fluid line to one of the actuators is too small. Another type of limitation might be a speed limitation, for example of an electric actuator.

Further, it is suggested that in case the unmodified commanded direction points in a downward and predominantly forward direction, the modification scheme reduces the input command of the length actuator and the input command of the pivot activator, wherein the reduction is the same for both actuators, or wherein the reduction for the length actuator is larger than the reduction for the pivot actuator. This is usually equivalent to a movement in quadrant IV that lies within angle α_{IV,i}<α<0°, which is presently denominated as quadrant IV,i. This time the control objective is to slow down the tool point velocity, since the tipping moment increases based on both aspects of actuation (variable boom length extension and variable length boom lowering). Therefore, the flow will be reduced for both aspects of movement. In particular, the same reduction factor can be applied. However, in particular in an effort to achieve a smooth changeover to the previously mentioned modification scheme (270°≤α<α_{IV}), it is also possible that the reduction for the length actuator is larger than for the pivot actuator (in particular using a varying factor). If the critical tipping moment is reached, the movement of the arrangement is stopped.

Furthermore, it is suggested that in case the unmodified commanded direction points in a downward/forward transition region between the forward and predominantly downward direction and the downward and predominantly forward direction, the modification scheme is applied in a way that the actual direction of the second end of the variable length boom is monotonically changed towards a vertical position, when approaching the commanded forward and predominantly downwards direction, in particular in a linear way. This downward/forward transition region is usually equivalent to a movement in the direction of quadrant IV that lies within angle α_{IV}≤α<α_{IV,i}, which is presently denominated as quadrant IV,ii. This way, any sharp change in the modification scheme can be avoided, which can be a nuisance to the operator, or which can even be dangerous since an operator might be surprised by a sudden change in behaviour of the variable boom loading arrangement albeit he applied a minuscule variation of the input command, only.

In particular is suggested that the limiting direction an (a borderline direction) between the commanded forward and predominantly downward direction and the command downward and predominantly forward direction, preferably between the commanded forward and predominantly downward direction and the downward/forward transition region, is a function of the commanded speed, wherein with a higher commanded actuation speed, the limiting direction an has an increasing component in the forward direction. In the presently chosen nomenclature, α_{IV}=α_{IV,i}+α_{IV,ii}. In particular, the angle α_{IV} may vary from −90° to −60°, preferably −80° to −70°, even more preferred about −75°, if no flow command is commanded by the operator. Then an (linearly) increases to −60° to −30°, preferably −50° to −40°, more preferably about −45° when 30% to 70%, preferably 40% to 60%, more preferably 55% to 65% of the maximum fluid flow is commanded by the operator. After this point an may further (linearly) increase to −20° to −10°, preferably −15°, when a flow command of 50% to 80%, more preferably 75% of the maximum flow is requested from the operator. Attention is directed to the fact that an has a negative value.

The size/magnitude of the transition angle α_{IV,ii} may be between 20° and 10°, preferably around 15°.

Further, it is suggested that when a changeover between two different modification schemes occurs, a transitional modification scheme is performed. This way, any annoying or disturbing behaviour can be advantageously avoided. The size of transition region can be determined using an angle. The angle, in which such a transition scheme may be employed may be −10° to 10°, preferably −5° to 5°, more preferably −3° to 3° on both sides of the borderline. Another approach would be to do the transition in terms of a certain time period and possibly a rate change of command. It is to be noted that a transition may particularly occur between quadrants (or between the sub-areas of quadrant IV). However, even within a quadrant or a sub-area of a quadrant, a transition might occur. For example, an actuation speed limit might be applied to one or both of the actuators for whatever reason, in particular for reason of limited available actuation power, as previously described.

Further, a variable boom loading arrangement, comprising an input device, a variable length boom that can be extended and retracted using a length actuator, wherein the first end of the variable length boom is pivotally attached to a frame, and wherein the variable length boom can be pivoted relative to a frame by means of a pivot actuator, wherein the variable length boom comprises a tool mount at a second end of the variable boom, is suggested. The variable boom loading arrangement further comprises an electronic control unit that inputs an input command that is applied to the input device by an operator and that applies an output signal to the length actuator and the pivot actuator. The electronic control unit is designed and arranged in a way that it performs a method according to the previous description. The variable boom loading arrangement can then show the same characteristics and advantages, as previously described, at least in analogy. Furthermore, the variable boom loading arrangement can be modified, at least in analogy, according to the previously given suggestions.

In particular, it is possible that the variable boom loading arrangement comprises at least one load sensor, one position sensor and/or one angle sensor.

Furthermore, the variable boom loading arrangement can be a part of a work vehicle, at telehandler, a telescopic loader, as telescopic wheel loader and the like.

### BRIEF DESCRIPTION OF THE DRAWINGS

Further advantages, features, and objects of the invention will be apparent from the following detailed description of the invention in conjunction with the associated drawings, wherein the drawings show:

FIG. 1: a schematic setup of a variable boom loading arrangement according to a possible embodiment in a schematic sketch;

FIG. 2: the possible range of movements for the tool point of an embodiment of a work vehicle with a variable boom loading arrangement in a schematic side view;

FIG. 3: a detail concerning the possible range of movements for the tool point of the work vehicle according to FIG. 2;

FIG. 4: a possible dependence of a maximum allowed flow limit in dependence of the position of the variable length boom relative to a predefined tipping moment;

FIG. 5: a graph, illustrating a possible dependence of the angle α_IV in dependence of the maximum allowed fluid flow;

FIG. 6: a schematic setup of a control scheme for employing a method for actuating a variable boom loading arrangement.

### DETAILED DESCRIPTION

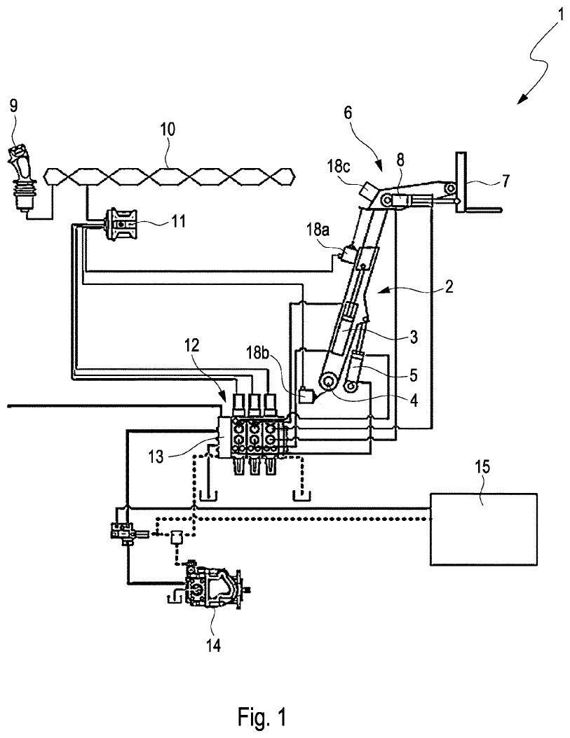

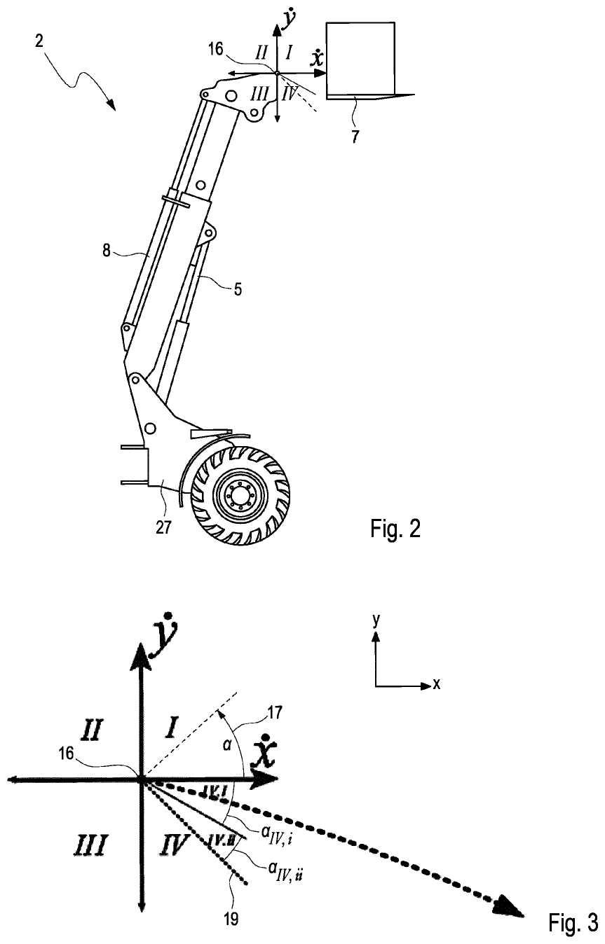

In FIG. 1, a schematic setup of a variable boom loading arrangement 1 according to a possible embodiment is shown as a schematic setup. As it is known as such in the prior art, the variable boom loading arrangement 1 comprises a variable length boom 2 that can be extended and retracted using a length actuator, presently a length varying hydraulic piston 3. Furthermore, the variable length boom 2 is pivotally attached to a frame, like a vehicle chassis 27 (not shown in FIG. 1; partially shown in FIG. 2) by means of a pivoting hinge 4. By appropriately actuating a pivot actuator that is presently designed as a pivoting hydraulic piston 5, the variable length boom 2 can be pivotally raised and lowered.

At its other end, opposite of the pivoting hinge 4, the variable length boom 2 shows a tool mount 6, to which a tool, presently a fork 7, can be attached. As it is also quite common in the prior art, the attitude of the fork 7 can be varied by means of a tilting actuator, which is presently designed as a tilting hydraulic piston 8.

The variable boom loading arrangement 1 is controlled by an operator. Presently, the input device for the operator is a control joystick 9. The control commands from the control joystick 9 are transmitted by means of a vehicle bus system 10 to an electronic controller 11. The electronic controller 11 performs the method, as presently proposed, and actuates a valve arrangement 12 that distributes the pressurised hydraulic oil of hydraulic pump 13. The outlets of the various actuated valves of the valve arrangement 12 is fed via hydraulic pipes and hydraulic hoses to the various actuators 3, 5, 8. Also, return lines are provided. The hydraulic pump 13 is driven by a combustion engine 14, that can also supply additional hydraulic consumers 15 (which is optional).

Furthermore, a plurality of sensors 18a, 18b, 18c is used. In the presently shown embodiment a variable length boom angle sensor 18b, a length sensor 18a, measuring the length of the variable length boom 2, and a load sensor 18c, measuring the load on the variable length boom 2/variable boom loading arrangement 1 are used.

By moving the control joystick 9, the operator commands to perform a movement of the tool point 16, which is representative of the second end of the variable length boom 2, to which a tool 7 is attached. The tool point 16 can be equivalent to a tool mount 6, in particular to a rotation axis of the tool 7, in case that the tool mount 6 is designed to tiltable.

FIG. 3 is an enlargement of the possible range of movements of the tool point 16. It is to be noted that depending on the actual position of the variable length boom 2 (with respect to length and angle), not necessarily all directions can be realised. As an example, if the variable length boom 2 is already fully extended, a movement in the extension direction of the variable length boom 2 is not possible, of course.

Letter x indicates a forward movement direction of the variable boom loading arrangement 1 (for example a telescopic loader), as seen in the external reference frame (the surroundings). The time derivative of x:

$$\dot{x} = \frac{dx}{dt}$$

is equivalent to the speed in the x-direction vₓ. Consequently, y denotes the vertical direction (upward) with

$${v}_{y} = \dot{y} = \frac{dy}{dt} .$$

The angle α is α=0° in the horizontal, forward direction. The value of a increases in the counter-clockwise direction 17 of FIGS. 2 and 3. Hence, 0°≤α<90°, can be addressed as quadrant I. Consequently, quadrant II is defined by 90°≤α<180°, quadrant III by 180°≤α<270°, and quadrant IV by 270°≤α<360°. Further, quadrant IV is divided into two sub-areas by transition line a_{IV} 19 at transition angle α_{IV}=α_{IV,i}+α_{IV,ii}. Please note that due to the conventions chosen, α_{IV}, α_{IV,i} and α_{IV,ii} usually show negative values.

In the presently shown example, α_{IV,ii} is chosen to be α_{IV,ii}=−15°. However, α_{IV,ii} and therefore α_{IV}=α_{IV,i}+α_{IV,ii} do vary with the commanded flow. An example of such a possible dependence is shown in FIG. 5. The abscissa 20 of FIG. 5 shows the flow rate, while the ordinate 21 shows the angle α_{IV} (negative value). If (almost) no flow is commanded by the operator, an is presently chosen to be α_{IV}=−90° (situation 22). With increasing flow demand, angle α_{IV} increases linearly (magnitude of angle decreases linearly). At situation 23, with a flow rate being approximately 50% of the maximum flow rate, the angle α_{IV} is now a α_IV=−45°. Here, a kink exists and again the magnitude of angle α_{IV} decreases towards situation 24, where the flow command is approximately 75% of the maximum fluid flow, and α_{IV}=−15°. Further increase in the commanded fluid flow does not alter angle α_{IV} any more.

Contrary to this variation, the size of the transition region α_{IV,ii} is presently chosen to be invariable; currently α_{IV,ii} is chosen to be α_{IV,ii}=−15°.

Depending on the direction that is commanded by the operator (raw, unmodified actuation), the input command signal is modified before it is applied to the various actuators 3, 5, 8 of the variable boom load arrangement 1. This will be described in detail in the following.

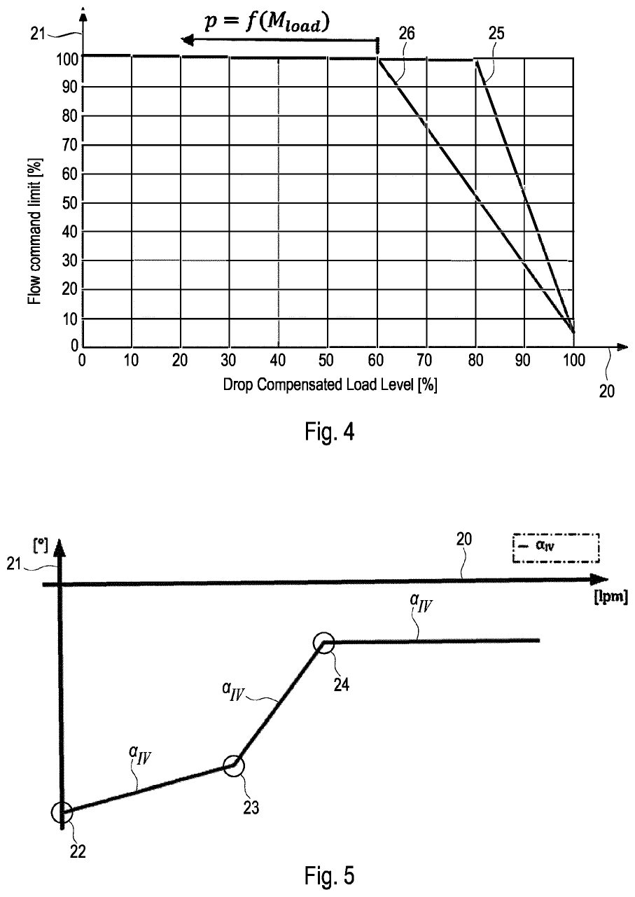

A particular method of modification is a reduction of the applied command by a multiplicative factor C with respect to the original input command. It is to be noted that this reduction will typically be dependent on the load level, as shown in FIG. 4 (which may also apply to the following formulae). In FIG. 4, the abscissa 20 shows the drop compensated load level in percent of the maximum, while the ordinate 21 shows the maximum flow as a percentage of the maximum flow rate possible. Drop compensation is a compensation that compensates for inertial effects. As an example, sometimes a drop in the load signal is seen when a fast lowering command is initiated, due to acceleration of the load. Drop compensation as such is known in the present technical field. It is to be noted, that the reduction factor C is presently chosen to be different for the variable length boom's length 25 (Cₜₑₗₑ) and for the variable length boom's angle/attitude 26 (C_{boom}).

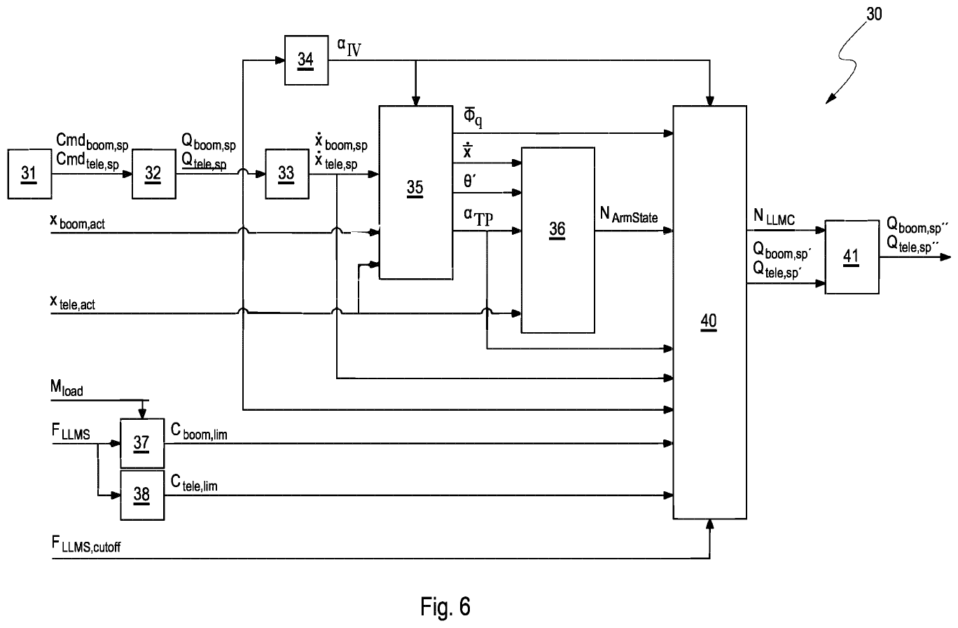

FIG. 6 shows a control schematic 30 that may be used for realising the method of actuating a variable boom loading arrangement 1 according to the present suggestion.

The input commands CMD_{boom,sp}, CMD_{tele,sp} that are entered by the joystick 9 are read in at block 31 (“boom” stands for actuation/position/speed of the pivoting actuator 5, “tele” stands for actuation/position/speed of the length variation actuator 3, “CMD” stands for command, “sp” for the unmodified command (no apostrophe)). These input commands CMD_{boom,sp}, CMD_{tele,sp} are consequently recalculated to fluid flow commands Q_{boom,sp}, Q_{tele,sp} (block 32; Q stands for fluid flow rate) and speeds for the actuators \dot{x}_{boom,sp}, \dot{x}_{tele,sp} (block 33). Also, sensor data from sensors 18a, 18b, 18c is read in, namely the position x_{boom,act} of the variable length boom 2, the length x_{tele,act} of the variable length boom 2, the mass M load and the load moment level (usually essentially the tipping over moment) from the load sensor F_{LLMS}, F_{LLMS,cutoff}. F_{LLMS} is the load moment level, while F_{LLMS,cutoff} is the reported “most critical load”, i.e. when movements increasing the load moment have to be stopped (LLMS=Load Level Moment Sensor). Furthermore, based on the input command that is read in from the joystick 31, block 34 calculates the position of transition line an, based on the commanded speed/fluid flows.

Various input data is fed into the forward kinematics 35, where various data is calculated from the input, in particular the position of the boom (angle θ, length x_{tele,act}), including the position x̅=(x, y) of the tool point in the x-y-reference frame, the direction of the unmodified commanded direction (raw input) in the x-y-reference frame

$$α = {tan}^{- 1} ( \frac{{\dot{x}}_{y}}{{\dot{x}}_{x}} )$$

and the Jacobian matrix Φ̅. Based on the calculated data, it is determined, which quadrant is commanded by the operator (block 36). This also includes which part of quadrant IV is commanded by the operator.

In parallel, based on additional input data, block 37 calculates the pivoting actuator's fluid flow limit C_{boom,lim}, and block 38 calculates the length varying actuator's fluid flow limit C_{tele,lim}.

All such input data, including data that is calculated therefrom, is fed into the LLMC core block 40 (LLMC=Longitudinal Load Moment Controller). Here, the input command by the operator is modified, depending in which quadrant (including sub-quadrant of quadrant IV) the unmodified commanded direction α is located. Consequently, a modified actuation command is calculated, and the requested fluid flows are applied to the various actuators (command application block 41).

The simplest “modification” is employed if the unmodified commanded direction α lies in quadrant II or III. In these quadrants, both aspects of movement bring the tool point 16 into a safer region, i.e. away from the predefined tipping moment (the critical tipping moment and/or the upper bound tipping moment). Therefore, the original operator input is simply left unmodified and consequently applied to the actuators 3, 5.

In case a small percentage of the maximum actuation speed is commanded (for example up to 5%, 10%, 15% of 20% of the maximum speed), this is considered to be a delicate operating situation, where the input command is-if necessary-reduced, where the reduction factor is the same for both aspects of movement, i.e. for the length variation command and for the pivoting command of the variable length boom 2. In other words, formulae

Q_{boom,sp′}=min(Q_{boom,sp},Q_{boom,raise,max}·C_{boom,lim},Q_{boom,raise,max}·C_{tele,lim})

and

Q_{tele,sp′}=min(Q_{tele,sp},Q_{tele,ext,max}·C_{tele,lim},Q_{tele,ext,max}·C_{boom,lim})

are used, where the “ext” stands for extension and “raise” speaks for itself.

If a faster actuation is applied (it is normally sufficient that only one aspect of the commanded movement is fast—i.e. the commanded actuation is not fully in the aforementioned slow command region) a distinction of cases is necessary.

In case the command is in a predominantly lowering state combined with a telescopic retraction or no telescoping, the situation is located in a sub-part of quadrant IV, lying between-90°≤α<α_{IV}. If, in this case, a somewhat fast movement is commanded by the operator, the flow command for the valves is maintained for the pivoting aspect (pivoting hydraulic piston 5), while a telescoping aspect (length variation hydraulic piston 3) is modified in a way that in the external reference frame a vertical lowering of the tool point 16 occurs.

For this, the following formulae are used:

$$[ \begin{matrix}{\dot{x}}_{boom , sp} \\ {\dot{x}}_{tele , sp}\end{matrix} ] = [ \begin{matrix}{Φ}_{{\overline{q}}_{1 , 1}}^{- 1} & {Φ}_{{\overline{q}}_{1 , 2}}^{- 1} \\ {Φ}_{{\overline{q}}_{2 , 1}}^{- 1} & {Φ}_{{\overline{q}}_{2 , 2}}^{- 1}\end{matrix} ] [ \begin{matrix}0 \\ {\dot{x}}_{y}\end{matrix} ] ,$$

which can be rewritten as

$${\dot{x}}_{tele , sp} = \frac{{\dot{x}}_{b oom , sp}}{{Φ}_{{\overline{q}}_{1 , 2}}^{- 1}} \cdot {Φ}_{{\overline{q}}_{2 , 2}}^{- 1} .$$

A corresponding modified flow command Q_{boom,sp′}, Q_{tele,sp′} will then be applied to the actuators. The apostrophe in “sp′” stands for the modified/corrected command.

If a boom raise command is combined with a telescopic extension, so that the unmodified commanded direction α lies in quadrant I, the control objective is to slow down the telescopic extension (length variation of the variable length boom) according to the telescopic flow limits as the longitudinal load moment increases. The pivoting aspect, however, is not altered. Hence, the following equations apply:

Q_{boom,sp′}=Q_{boom,sp}

Q_{tele,sp′}=min(Q_{tele,sp},Q_{tele,ext,max}·C_{tele,lim}).

In case of a predominantly horizontal movement state of the tool point 16, with no or little lowering of the tool point 16, the control objective is to slow down the tool point 16 velocity \overline{\dot{x}}=(\dot{x}ₓ, \dot{x}_{y}) according to the boom/telescopic flow limits C_{boom,lim}, C_{tele,lim} as longitudinal load moment increases. Therefore, the following formulae are used:

Q_{boom,sp′}=max(Q_{boom,sp},Q_{boom,rtr,max}·C_{boom,lim}) and

$${Q}_{tele , {sp}^{′}} = min ( {Q}_{tele , sp} \cdot \frac{{Q}_{boom , {sp}^{′}}}{{Q}_{boom , sp}} , min ( {Q}_{tele , ext , max} \cdot {C}_{tele , lim} ) ) ,$$

where the index “rtr” stands for retraction, while the index “ext” stands for extension.

To achieve a soft changeover between regions 270°≤α≤α_{IV} and α_{IV}≤α<0°, a transition range is present in region α_{IV,ii}≤α<α_{IV,i}, in which the following formula is used

$${\dot{x}}_{x , {sp}^{′}} = {\dot{x}}_{x} \cdot ( \frac{\vert {α}_{T P} \vert - ( \vert {α}_{IV} \vert - {α}_{IV , II} )}{\vert {α}_{IV} \vert - ( \vert {α}_{IV} \vert - {α}_{IV , II} )} \cdot ( - 1 ) + 1 ) ,$$

in an effort to scale x′_x from its full value to 0 and vice versa.

Since this is a transition from predominantly horizontal movement to vertical movement, Q_{boom,sp′} (as specified in the appropriate formula in the last paragraph) is used as a boom command reference, hence:

$${q}^{\dot{¯}} = {{Φ}^{\overline{\_}}}_{\overline{q}}^{- 1} {x}^{\dot{¯}} ⇒$$

$${\dot{x}}_{y , {sp}^{′}} = \frac{{\dot{x}}_{b oom , {sp}^{′}} - {\dot{x}}_{x , {sp}^{′}} \cdot {Φ}_{{\overline{q}}_{1 , 1}}^{- 1}}{{Φ}_{{\overline{q}}_{1 , 2}}^{- 1}} ,$$

$$and finally {\dot{x}}_{t e l e , {sp}^{′}} = {Φ}_{{\overline{q}}_{2 , 1}}^{- 1} \cdot {\dot{x}}_{x , {sp}^{′}} + {Φ}_{{\overline{q}}_{2 , 2}}^{- 1} \cdot ( \frac{{\dot{x}}_{b oom , {sp}^{′}} - {\dot{x}}_{x , {sp}^{′}} \cdot {Φ}_{{\overline{q}}_{1 , 1}}^{- 1}}{{Φ}_{{\overline{q}}_{1 , 2}}^{- 1}} ) .$$

As a matter of completeness it should be pointed out that the previous formulae apply to the case that the available actuation power for the actuators is sufficient to fulfill the power requirements of the actuators/to realise the above described actuation schemes. As already mentioned, if this should not be the case, a reduction has to be applied to the actuators in an appropriate way that the available actuation power is sufficient.

Furthermore, in case different types of actuators are used (for example electric actuators), the formulae have to be adopted appropriately. This, however, is a straightforward task for a person skilled in the art. As an example: In case of electric actuators, the actuation speed is dependent on the applied voltage, current and/or frequency (no fluid flux occurring).

What is claimed is:

1. A method of actuating a variable boom loading arrangement, comprising a variable length boom that can be extended and retracted using a length actuator,
wherein a first end of the variable length boom is pivotally attached to a frame, and wherein the variable length boom can be pivoted relative to the frame by means of a pivot actuator,
and wherein a second end of the variable length boom is used for handling loads,
wherein an input command that is given by an operator is modified if the variable boom loading arrangement reaches a predefined tipping moment, resulting in a modified output command to the actuators, so as to avoid a tipping of the variable boom loading arrangement,
wherein the input command is used to calculate an unmodified commanded direction of the second end of the variable length boom in an external reference frame, in particular in an external Cartesian coordinate reference frame, wherein the modification scheme that is applied to the input command and that results in a modified output command to the actuators depends on the calculated unmodified commanded direction in the external reference frame.

2. The method according to claim 1, wherein the data of at least one load sensor, one position sensor and/or one angle sensor is used as an input for determining the predefined tipping moment.

3. The method according to claim 1 wherein the second end of the variable length boom relates to a tool mounting point.

4. The method according to claim 1, wherein the predefined tipping moment comprises a critical tipping moment, wherein irrespective of the commanded actuation of at least one of the actuators the modified output command to the respective actuator is zero, at least for certain modification schemes and/or at least for certain calculated unmodified commanded directions in the external reference frame.

5. The method according to claim 4, wherein the predefined tipping moment comprises a range between an upper bound tipping moment and the critical tipping moment, wherein only a reduced amount of the commanded actuation of at least one of the actuators is applied to the respective actuator as the modified output command, at least for certain modification schemes and/or at least for certain calculated unmodified commanded directions in the external reference frame, wherein preferably the fraction of the commanded actuation is monotonically decreased, in particular linearly decreased.

6. The method according to claim 1, wherein below a certain size of the input command, the commanded actuation of the actuators will be modified in a way that the calculated unmodified commanded direction in the external reference frame is not changed, at least for certain modification schemes and/or at least for certain calculated unmodified commanded directions in the external reference frame.

7. The method according to claim 1, wherein the commanded actuation of the actuators is not modified if the calculated unmodified commanded direction in the external reference frame brings the second end of the variable length boom away from the predefined tipping moment, in particular the critical tipping moment and/or the upper bound tipping moment.

8. The method according to claim 1, wherein in case the unmodified commanded direction points in an upward and forward direction, the modification scheme reduces the input command of the length actuator, while it maintains the input command of the pivot actuator.

9. The method according to claim 1, wherein in case the unmodified commanded direction points in a forward and predominantly downward direction, the modification scheme maintains the input command of the pivot actuator, while the input command of the length actuator is modified in a way that the actual direction of the second end of the variable length boom is the vertical direction, where in case the available actuation power is not sufficient to maintain this modification scheme, the modification scheme reduces the input command of the length actuator and the input command of the pivot actuator, wherein the reduction is chosen in a way that the actual direction of the second end of the variable length boom is the vertical direction and the available actuation power can maintain the modified command.

10. The method according to claim 1, wherein in case the unmodified commanded direction points in a downward and predominantly forward direction, the modification scheme reduces the input command of the length actuator and the input command of the pivot actuator, wherein the reduction is the same for both actuators, or wherein the reduction for the length actuator is larger than the reduction for the pivot actuator.

11. The method according to claim 10, wherein in case the unmodified commanded direction points in a downward/forward transition region between the forward and predominantly downward direction, and the downward and predominantly forward direction, the modification scheme is applied in a way that the actual direction of the second end of the variable length boom is monotonically changed towards a vertical direction, when approaching the commanded forward and predominantly downward direction, in particular in a linear way.

12. The method according to claim 10, wherein the limiting direction between the commanded forward and predominantly downward direction and the commanded downward and predominantly forward direction, preferably between the commanded forward and predominantly downward direction and the downward/forward transition region, is a function of the commanded speed, wherein with a higher commanded actuation speed, the limiting direction has an increasing component in the forward direction.

13. The method according to claim 1, wherein when a changeover between two different modification schemes occurs, a transitional modification scheme is performed.

14. A variable boom loading arrangement comprising an input device, a variable length boom that can be extended and retracted using a length actuator,
wherein a first end of the variable length boom is pivotally attached to a frame, and wherein the variable length boom can be pivoted relative to the frame by means of a pivot actuator,
wherein the variable length boom comprises a tool mount at a second end of the variable length boom,
the variable boom loading arrangement further comprising an electronic control unit that inputs an input command that is applied to the input device by an operator and that applies an output signal to the length actuator and the pivot actuator,
wherein the electronic control unit is designed and arranged in a way that it performs the method according to claim 1.

15. The variable boom loading arrangement according to claim 14, wherein at least one load sensor, one position sensor and/or one angle sensor.
